(19) United States
(12) Patent Application Publication
(10) Pub. No.: US 2014/0151558 A1
(43) Pub. Date: Jun. 5, 2014

(54) OCCUPANCY SENSOR

(71) Applicants: Enrico Bortot, Volpago (IT); Christian Cecchetti, Istrana (IT); Stefan Hackenbuchner, Treviso (IT); Uwe Liess, Muenchen (DE); Torsten Mannke, Winhoering (DE)

(72) Inventors: Enrico Bortot, Volpago (IT); Christian Cecchetti, Istrana (IT); Stefan Hackenbuchner, Treviso (IT); Uwe Liess, Muenchen (DE); Torsten Mannke, Winhoering (DE)

(73) Assignee: OSRAM GMBH, Muenchen (DE)

(21) Appl. No.: 13/984,546

(22) PCT Filed: Mar. 11, 2011
(86) PCT No.: PCT/IB11/51037

§ 371 Date: Feb. 13, 2014

Related U.S. Application Data
(60) Provisional application No. 61/440,885, filed on Feb. 9, 2011.

(51) Int. Cl. G01J 5/10

(52) U.S. Cl. CPC G01J 5/10
USPC 250/338.1

(57) ABSTRACT

An occupancy sensor with the following components is disclosed: a sensing probe to detect occupancy of a space monitored by the sensor and to produce a corresponding sensing signal; a comparator, including a voltage divider defining a comparison value, against which the sensing signal is compared to detect occupancy; and a voltage sensing means to sense a feed voltage applied to the sensor, where changes in the feed voltage to the sensor induce a change in the comparison value.

### FIELD OF THE INVENTION

The disclosure relates to occupancy-based control techniques.

In various embodiments, the disclosure may relate to controlling lighting sources based on occupancy.

### BACKGROUND

Systems for controlling lighting sources, e.g. luminaries L, installed in a space to be lighted e.g. a room in a school, kindergarten or the like (as schematically shown in FIG. 1) may include sensors S to detect occupancy of the space and cause the lighting source L to be activated e.g. without any manual intervention on switches or the like.

In such systems configured as wireless networks with multiple occupancy sensors S bound to the same actuated device (e.g. a luminaire or a group of luminaires or any other device to be activated as a function of occupancy), every single sensor S periodically reports its detected occupancy state (occupied/not occupied) to the actuated device. This means that state reports are sent even if there is no presence in the detection area which is a common condition in most practical cases.

On the one hand, this type of operation leads to high energy consumption on the sensor side, because transmitting and receiving usually is responsible for the largest part of the energy consumption in the energy budget of the sensor device. Especially for battery-powered devices this reduces significantly the battery lifetime. On the other hand, it becomes quite complicated for the actuated device to handle two different states reported from different sensor devices.

For doing that, the actuated device has to be informed about the total number of sensors bound to it and which sensor device sent which state.

For example, a luminaire which has received a “not occupied” status report has to know if there are other sensor devices which might send “occupied” state reports.

The inventors have noted that these problems may be addressed by:
using just a single actuator per network to transmit only status changes;
using multiple sensors, which will then result in non-synchronized switching and confusion of the user;
using more batteries or a permanent power supply;
causing the sensor devices always to listen to the wireless traffic and modify (e.g. synchronize) their own state reports according to the state reports of the other devices (e.g. no “not occupied” reports are sent as long as the other devices are sending “occupied” ones); this may means that the radios of the sensor devices have to be switched on all the time and this again, may have a strong impact on power consumption.

Also, for handling different state reports from several devices the actuated device has to be informed about the total number of sensors bound to it and which sensor device sent which state; addressing this problem may require logic combinations (e.g. the actuated device such as e.g. a luminaire switches off only if all known sensor devices report a “not occupied” state): this requires a certain amount of memory in the actuated device, which is usually quite rare and also expensive.

Also, the inventors have noted that in wireless networks with battery-powered occupancy sensors, reducing the energy consumption of the sensor modules is essential for ensuring a long lifetime (e.g. several years for standard batteries may be desirable).

The inventors have similarly noted that the output voltage may decrease more than 30 percent over the lifetime of standard alkaline batteries, which has a strong impact on the power supply of the sensor and the circuit for signal conditioning which may be associated therewith.

In the case of battery-powered occupancy sensors using a PIR (Passive Infra Red) sensor or probe, a decreasing battery voltage may lead to an undesired increased sensitivity with the ensuing increased risk of wrong detections. This is due to the fact that in various embodiments the signal conditioning circuit(s) may derive the signal levels from the battery voltage.

The inventors have noted that this undesired effect might be avoided by using special batteries (e.g. lithium batteries, which may maintain their output voltage over most of their lifetime and exhibit a voltage drop only at the very end of their lifetime) or by using solar panels in possible conjunction with batteries to provide energy to the sensors.

Such arrangements are inevitably expensive and unpractical.

### OBJECT AND SUMMARY

The invention has the object of overcoming the drawbacks of the solutions outlined previously.

According to the present invention, the above object is achieved thanks to the characteristics set forth in the claims that follow.

The claims form an integral part of the technical disclosure of the invention provided herein.

In certain embodiments, to reduce the radio on time, and therefore the power consumption, only the status “occupied” may be periodically transmitted over the air (i.e. as a radio signal, as may be the case in a wireless system) as long as the sensor device is detecting presence while in the “unoccupied” state nothing is transmitted.

In certain embodiments, in order to reduce energy consumption, a message is transmitted to the system only if presence (i.e. occupancy) is detected; otherwise there is no communication to the network.

In certain embodiments, the actuated device (directly or via some other permanently powered sensor data aggregation devices) listens to the sensors—and other control devices (e.g. switches and remote controls) bound to them—and have an own internal logic (e.g. retriggerable timer) to decide about turning on or off the load (e.g. lamps) depending on the received trigger signals (“occupied” state reports) and the status reports of the other control devices influencing the behavior.

In certain embodiments, the time between the “occupied” state reports of the sensor devices may be used to optimize energy consumption.

In certain embodiments, the actuated device may be additionally informed about the reporting interval (e.g. by a fixed configuration or, to be more flexible, as additional information together with the “occupied” state report) and may automatically react (e.g. by switching the light off) if the reporting interval is exceeded with no further status report received within the reporting interval from any device. In this case it does not matter if the status report was sent by a single sensor device or multiple sensor devices, because each received status report may just reset the timer which controls the reporting interval in the actuated device.

In certain embodiments, the actuated device will not have to be necessarily aware of the number and the individual status of each sensor device, because it will just automatically act as long as “occupied” state reports are received within the known reporting interval time and will react according to its application (e.g. switching off) if no state reports are received any more.

In certain embodiments, the actuated device may also listen to commands of manual control devices and override the sensor state reports according to them if necessary.

In certain embodiments, it will not be necessary for the sensor device to have the radio switched on all the time, as it will be enough to switch it on only when the reporting interval is exceeded and a presence has to be reported. For the rest of the time the device can be in low power mode with the radio switched off.

In certain embodiments, it will be enough for the sensor device to switch its radio on only when the reporting interval is exceeded and a presence has to be reported; for the rest of the time, the device can be in sleep mode.

In certain embodiments, in order to achieve a long battery lifetime the sensor (and primarily the microcontroller that may be included therein) may be in a sleep mode as long as no person is within the detection area.

In certain embodiments, a circuit which comprises the signal conditioning functions of the sensor is may consume only a few microamperes and wake up the microcontroller as soon as presence is detected.

Certain embodiments may compensate the change in sensitivity of signal monitoring of the occupancy sensors due to decreasing battery voltage.

### BRIEF DESCRIPTION OF THE ANNEXED FIGURES

The invention will now be now described, purely by way of non-limiting example, with reference to the annexed figures, wherein:

FIG. 1 has been already described in the foregoing;

FIG. 2 is a time diagram showing signals generated in certain embodiments; and

FIGS. 3 and 4 are block diagrams of occupancy sensors.

### DETAILED DESCRIPTION

In the following description numerous specific details are given to provide a thorough understanding of embodiments. The embodiments can be practiced without one or more of the specific details, or with other methods, components, materials, etc. In other instances, well-known structures, materials, or operations are not shown or described in detail in order to avoid obscuring aspects of the embodiments.

Reference throughout this specification to “one embodiment” means that a particular feature, structure, or characteristic described in connection with the embodiment is included in at least one embodiment. Thus, the appearances of the phrase “in certain embodiments”, in various places throughout this specification are not necessarily all referring to the same embodiments. Furthermore, the particular features, structures or characteristics may be combined in any suitable manner in one or more embodiments.

The headings provided herein are for convenience only and do not interpret the scope or meaning of the embodiments.

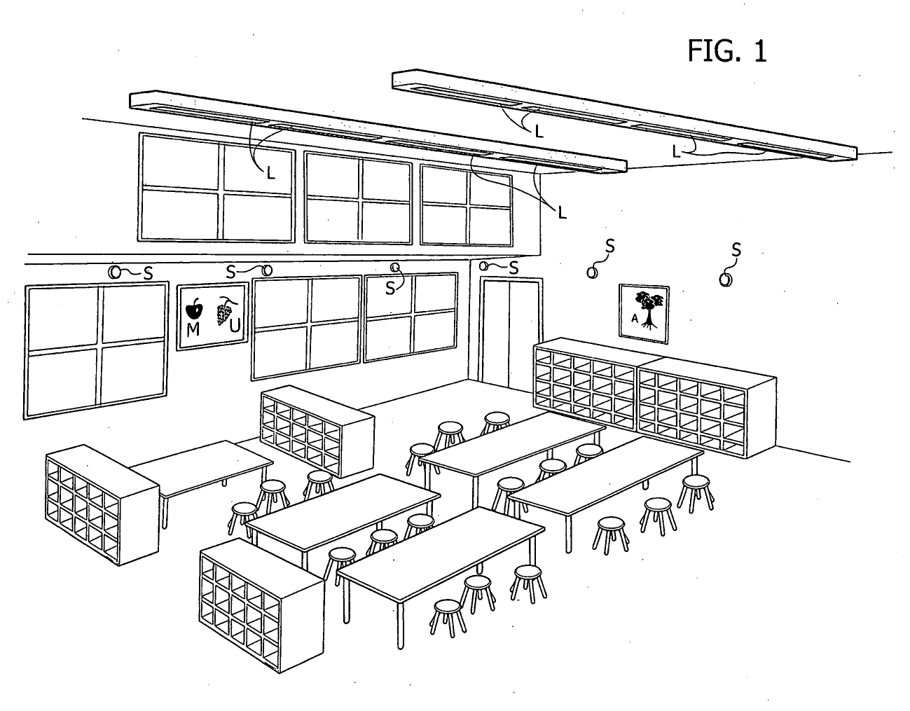

As already indicated, FIG. 1 is schematically representative of an occupancy-based control system, in the exemplary form of a system for controlling a lighting source, e.g. one or more luminaries L, installed in a space to be lighted e.g. a room in a school, kindergarten or the like. The system includes a plurality of sensors S to detect occupancy of the space and cause the lighting source L to be actuated.

The exemplary system illustrated in FIG. 1 is configured as wireless network with multiple occupancy sensors S bound to the same actuated device (e.g. a lighting source L such as a luminaire or a group of luminaires or any other device to be activated as a function of occupancy). Activation of the controlled device may be either directly or via some other permanently powered sensor data aggregation device, i.e. a device adapted to collect the signals from the (e.g. battery operated) sensors S and to activate/deactivate the controlled device accordingly.

Save for what will be described in the following, the general layout and operation of the system including the actuated device (e.g. a lighting source L) and the occupancy sensors S is conventional in the art, thus making it unnecessary to provide a more detailed description herein.

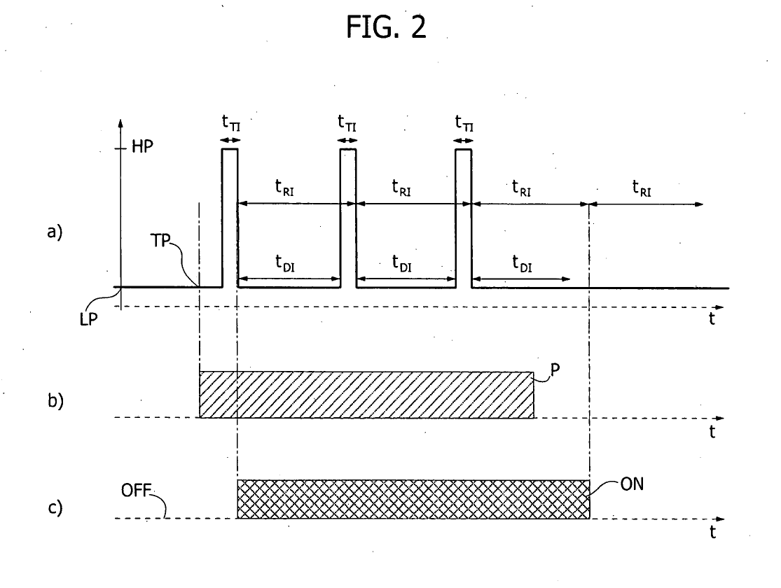

FIG. 2, including three portions designated a), b), and c), respectively, is a time diagram showing, over a common time scale t:
an exemplary output signal emitted by any of the sensors S (portion a);
the presence P of a person (i.e. the occupancy) detected by the sensor in question (portion b); and
the activation(ON)/de-activation(OFF) of the device (e.g. a lighting source such as e.g. one or more luminaries) actuated i.e. controlled by the system.

The output signal emitted by the sensor(s) varies between a low power level LP and a high power level HP.

The representation of FIG. 2 assumes that the output signal is at the low power level LP when a “presence” P (i.e. an occupancy) is detected at a time TP.

As a result of this, the sensor switches for a time frame t_{TI} to high power mode (radio turned on) in which the sensor connects to the network to get in contact with the actuated device L (or its bound actuators) to send its “occupied” state reports and then returns to the low power level LP.

In FIG. 2, t_{DI} denotes the time between two high power node time frames t_{TI} in which the sensor device is in low power mode LP (radio turned off). In this mode the device may be running its application for detecting presence or being asleep.

Finally, in FIG. 2, t_{RI} denotes the time frame between two “occupied” state reports. An internal timer associated with the actuated device (e.g. the lighting source) is set to this value after having received an “occupied” state report. If another “occupied” status report is received within this time the timer is reset to t_{RI}. If no “occupied” status report is received within that time span the actuator will switch off its load.

It will be appreciated that neither the power consumption nor the time line is scaled. In reality the time t_{TI} for transmitting and receiving will be generally much shorter in comparison with t_{DI}.

Also the difference between “low power mode” LP and “high power mode” HP will be relatively much larger than the difference between the base line and “low power modes”.

In the exemplary embodiments considered herein:
the state reports are not sent periodically in general, but only the “occupied” state is transmitted if some presence P is detected and this report is sent periodically only as long as the state does not change to unoccupied;
additionally, the acting device may be informed about the reporting interval (e.g. by a fixed configuration) and automatically react (e.g. by switching the light off) if the reporting interval is exceeded and no further status report has been received within the reporting interval from any device: in this case, it does not matter if the status report was sent by a single sensor device or multiple sensor devices, because every received status report just resets the timer which controls the reporting interval in the acting device.

As a result, in the exemplary embodiments considered herein, it is not necessary for the activated device L to be aware of all sensor devices S, because it will just automatically act as long as “occupied” state reports are received within the known reporting interval time and react according to its application (e.g. switching off) if no state reports are received anymore. Consequently, it will not be necessary for the sensor device to have the radio switched on all the time.

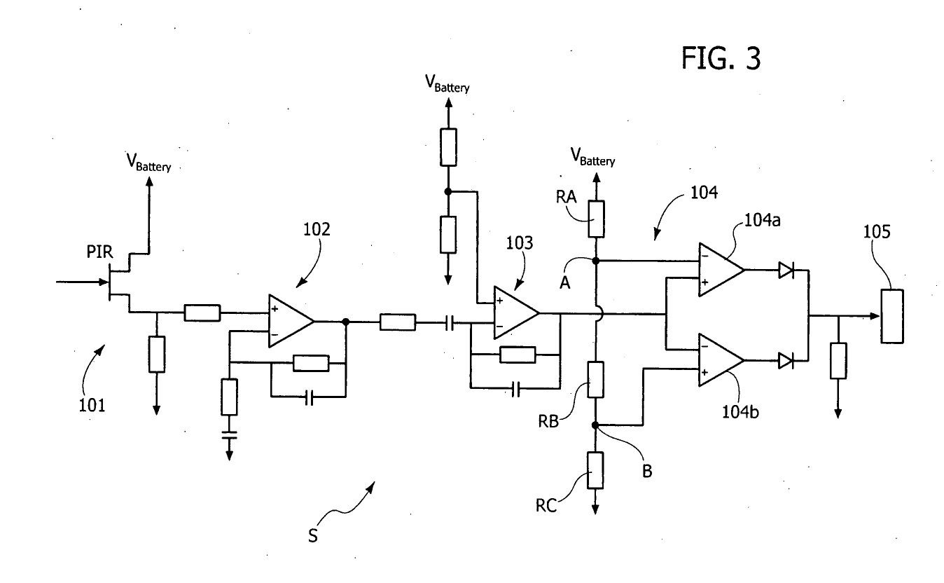

The block diagram of FIG. 3 is representative of an occupancy sensor S using a sensitive element 101—of any known type, e.g. a PIR (Passive Infra Red) sensor or probe.

The signal produced thereby (which may be indicative of occupancy, e.g. the presence of one or more persons in the detection area covered by the sensor S) may be amplified and filtered by two or more cascaded amplifier stages 102, 103. The resulting signal thus possibly conditioned is fed to a window comparator 104 including two comparator elements such as e.g. operational amplifiers 104a, 104b defining upper and lower thresholds or limits, respectively. When the signal fed to the comparator 104 reaches a certain upper or lower threshold level, the output of the window comparator 104 changes from low to high and may “wake up” the circuitry (e.g. a microcontroller) 105 of the sensor which was previously in “sleep” mode, with reduced consumption.

Certain embodiments may adopt such a window comparator (that is two thresholds) as the probe 101 may provide, when no movement is detected, a constant output voltage lying between the upper and lower levels thresholds of the window comparator and react only to a change of the infrared radiation.

For instance, the probe 101 may include a lens with several facets which project the infrared radiation on the sensing surface: when a person moves from the area covered by one facet to the area covered by another facet, the infrared radiation onto the sensor surface changes and the sensor signal increases or decreases (depending on the direction of the movement); consequently, the signal (which is between the upper and lower level of the window comparator when no movement is detected) may go up (and exceed the upper level) or down (und go below the lower level). In certain embodiments, the signal-conditioning circuitry (e.g. 102, 103) may amplify only this change of the sensor output voltage.

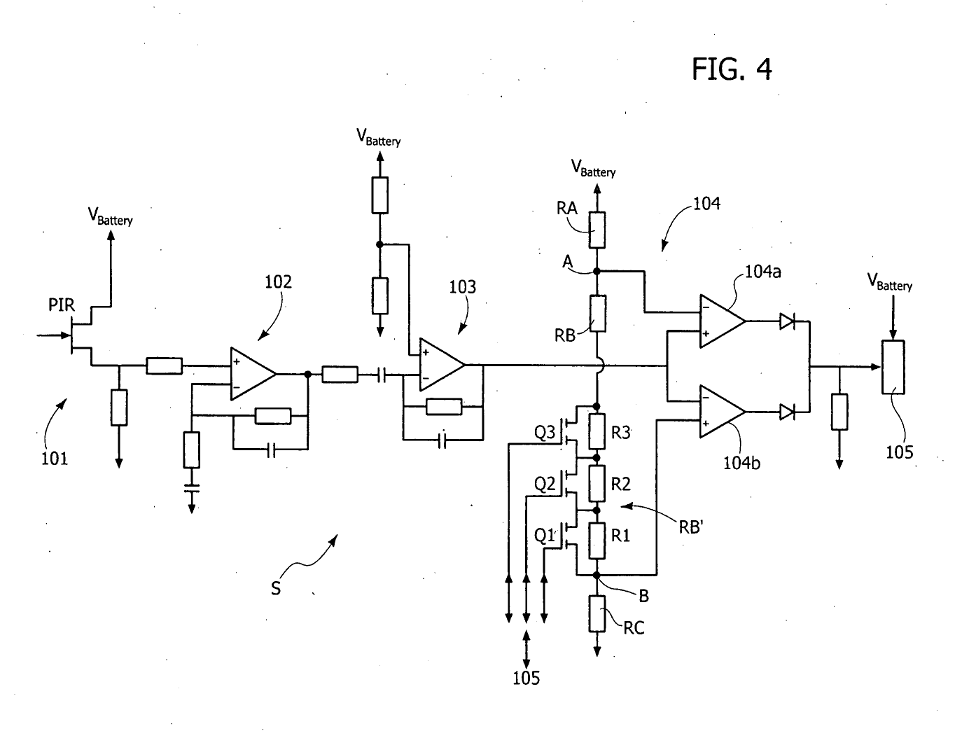

A basic concept underlying the exemplary embodiment of FIG. 3 (and similarly of FIG. 4) is having a voltage divider which defines at least one comparison value against which the signal produced by the sensor or probe 101 (as possibly conditioned by the stages 102 and 103) is compared to detect presence/occupancy in the detection area of the sensor S.

In the exemplary embodiment of FIG. 3, the voltage divider interposed between the power voltage (V_{Battery}) and ground includes first, second and third resistors RA, RB, RC in series.

The intermediate point A between the first and second resistors RA and RB is connected to the inverting input of the op-amp 104a and thus defines the upper threshold or limit of the detection window of the comparator 104.

The intermediate point B between the second and third resistors RB and RC is connected to the non-inverting input of the op-amp 104b and thus defines the lower threshold or limit of the detection window of the comparator 104.

This means that the voltage divider RA, RB, RC defines at least one comparison value against which the signal produced by the sensor or probe 101 (as possibly conditioned by the stages 102 and 103) is compared to detect presence/occupancy in the detection area of the sensor S and correspondingly wake-up the transmitting part of the sensor (i.e. the microcontroller 105).

In such a sensor S, when battery powered (i.e. with the various elements 101, 102, 103 and—primarily 104—fed with a voltage V_{Battery}—derived from one or more batteries) a decreasing battery voltage V_{battery} may lead to an undesired increased sensitivity with the ensuing increased risk of wrong detections.

This effect is largely independent of a number of factors, such as e.g.:
the type of the sensor element 101,
the specific circuit layout of the stages 102, 103, and
the specific arrangement of the elements defining the comparison value or values of the comparator 104.

The following disclosure provided in connection with FIG. 4 will thus also apply e.g. to sensor elements 101 other than a PIR probe, as well as to conditioning stages 102, 103 (if present) and a comparator 104 having a layout different from the one exemplified in. FIGS. 3 and 4.

In that respect, parts and components which are identical or equivalent are indicated with the same references in both FIGS. 3 and 4; for the sake of brevity, the relative description already provided in connection with FIG. 3 will not be repeated in connection with FIG. 4.

In the exemplary embodiment of FIG. 4, before being fed to the comparator 104, the signal from the sensor 101 (e.g. PIR) is passed through the stages 102 and 103 for conditioning before being fed to the comparator 104. The comparator 104 monitors the signal and wakes up the microcontroller 105 as soon as movement is detected.

The microcontroller 105 sends a RF message to the wireless network (e.g. to switch on the light source L with a message to the network to switch on the light source for a certain time Tₒₙ) and returns to the sleep mode immediately thereafter.

In certain embodiments, the possibility for the microcontroller 105 to wake-up may be inhibited, that is de-activated, for a certain off-time (e.g. 2 seconds).

When in the sleep mode (and not possibly temporarily inhibited) the microcontroller 105 can be woken-up again by the sensor.

In certain embodiments, the microcontroller 105 may be configured so that, whenever woken-up by the sensor, the microcontroller 105 checks if the end of the time period Tₒₙ is reached, and in that case the message “light on for Tₒₙ” may be renewed.

The exemplary embodiment considered herein may be adapted to operate with standard alkaline batteries having an output voltage which decreases (e.g. linearly) during the battery lifetime. This may result i.a. into a corresponding change (e.g. decrease) in the width of the detection window of the comparator 104, with the ensuing drawbacks already discussed in the foregoing (increased sensitivity, increased risk of wrong detections).

In certain embodiments, this undesired effect may be compensated by causing the resistance RB between the points A and B (see FIG. 3) to be replaced or supplemented (as depicted in FIG. 4) by a set of resistors R1, R3, R3, . . . , Rn having associated electronic switches Q1, Q2, Q3 . . . , Qn (such as e.g. MOSFETs) controlled e.g. by the micro controller 105. In the exemplary embodiment illustrated in FIG. 4, n=3.

When “on” (i.e. conductive), each switch Q1, Q2, Q3, . . . will short-circuit the respective resistor R1, R3, R3, . . . thus yielding a zero resistance.

When “off” (i.e. non-conductive), each switch Q1, Q2, Q3, . . . will permit the respective resistor R1, R3, R3, . . . to add a non-zero resistance value to the resistance between the points A and B.

In the exemplary embodiment considered, “digitally” (i.e. on/off) activating an increasing number of the resistors R1, R3, R3, . . . will cause the voltage at A to increase and the voltage at B to decrease, with a consequent effect on the width the detection window of the comparator 104 in order to compensate for the change (e.g. decrease) in the detection window width due to the change (e.g. decrease) in the battery voltage V_{battery}.

The exemplary embodiment considered will minimize current (i.e. power) absorption since electronic switches Q1, Q2, Q3, . . . such a MOSFETs will exhibit a current absorption in the range of microamperes.

Also, in certain embodiments, selecting resistance values as R1=R, R2=2R, R3=4R, . . . , Rn=R2̂(n−1)—that is with resistance values arranged in an increasing series of powers of two—will permit to control the detection window with 2̂n equidistant levels.

In certain embodiments, switching (i.e. selectively turning on and off) the switches Q1, Q2, Q3, . . . may be controlled by the microcontroller 105.

In order to do so, the microcontroller 105 may sense the voltage V_{battery} either directly (as depicted in FIG. 4) or indirectly (e.g. by sensing a voltage at a point of the divider at the input of the comparator 104) and act on the switches Q1, Q2, Q3, . . . to maintain the voltage drop between A and B (substantially) constant.

In certain embodiments, a simple procedure to do this may involve activating the resistors R1, R2, R3 in such a way that the sum of the resistance values of the resistors activates gradually increases as the voltage V_{battery} decreases.

A concept underlying the exemplary embodiment of FIG. 4 can thus be summarized as involving two basic steps:
detecting any changes (e.g. a decrease) in the voltage (e.g. V_{battery}) which powers the sensor S, and
acting on a voltage divider which defines at least one comparison value of a comparator against which the signal produced by the occupancy sensor or probe is compared in order to keep the at least one comparison value substantially constant, thus countering any changes induced thereon by a change (e.g. a decrease) in the voltage which powers the sensor S.

In certain embodiments (such as exemplified in FIG. 4) the signal produced by the occupancy probe 101 is compared against a comparison value given by the width of a window (i.e. between an upper and a lower threshold). Any changes (e.g. a decrease) in the voltage which powers the sensor S being detected may lead to acting on the voltage divider (RA, RB, R1, R2, R3, RC) in order to keep the width of said window substantially constant.

Of course, without prejudice to the underlying principles of the invention, the details of construction and the embodiments may vary, even significantly, with respect to what is described and illustrated herein, without thereby departing from the scope of the invention, as defined by the annexed claims.

1. An occupancy sensor including:
a sensing probe to detect occupancy of a space monitored by the sensor and produce a corresponding sensing signal,
a comparator including a voltage divider defining a comparison value against which said sensing signal is compared to detect said occupancy,
a voltage sensing means to sense a feed voltage applied to the sensor, wherein changes in said feed voltage induce a change in said comparison value,
said voltage divider including at least one resistor selectively switchable to counter changes induced in said comparison value by changes in said feed voltage.

2. The sensor of claim 1, wherein said voltage divider defines a comparison window for said sensing signal with a width between an upper threshold and a lower threshold, wherein said voltage divider includes at least one resistor selectively switchable to counter changes in the width of said comparison window induced by changes in said feed voltage.

3. The sensor of claim 1, wherein said voltage divider includes a plurality of resistors wherein at least one resistor in said plurality is selectively switchable between two different resistance values.

4. The sensor of claim 3, wherein at least one resistor in said plurality is selectively switchable between a zero resistance value and a non-zero resistance value.

5. The sensor of claim 3, wherein said plurality of resistors includes a set of resistors switchable to resistance values arranged in an increasing series of powers of two.

6. The sensor of claim 3, wherein said at least one selectively switchable resistor is coupled to an associated electronic switch switchable to an active state to short-circuit the resistor coupled thereto.

7. The sensor of claim 6, wherein said electronic switch includes a MOSFET.

8. The sensor of claim 1, including a controller configured to selectively switch said at least one resistor in said voltage divider to counter changes induced in said comparison value by changes in said feed voltage.

9. The sensor of claim 8, wherein said controller is configured to selectively switch a plurality of switchable resistors in said voltage divider to cause the sum of the resistance values of the resistors activated by said switching to gradually increase as said feed voltage decreases.

10. The sensor of claim 8, wherein said controller comprises said voltage sensing means.

11. The sensor of claim 1, including a controller, configured to be selectively switched to an active state as comparison of said signal sensing signal against said comparison value in said comparator indicates occupancy being detected by said sensing probe.

12. The sensor of claim 11, wherein said controller is coupled to a radio transmitter to send a RF message when occupancy is detected by said sensing probe.

13. The sensor of claim 12, wherein said controller is configured to return to a sleep mode after sending said RF message.

14. The sensor of claim 13, wherein said controller is inhibited from switching to said active state for a given interval after returning to said sleep mode.

15. The sensor of claim 1, wherein said sensing probe is a Passive Infra Red or PIR sensing probe.

16. The sensor of claim 1, including conditioning circuitry for said sensing signal between said sensing probe and said comparator.

17. The sensor of claim 1, wherein the sensor is a battery-powered sensor whereby said feed voltage is battery voltage.
